(19) United States
(12) Patent Application Publication
(10) Pub. No.: US 2022/0300994 A1
(43) Pub. Date: Sep. 22, 2022

(54) SYSTEM FOR EFFECTIVE MEDIA TAG MANAGEMENT AND METHOD THEREOF

(71) Applicant: Digital M/Ad Tech LLC, Overland Park, KS (US)

(72) Inventors: Mahesh Reddy, Overland Park, KS (US); Sajith Sankaranarayanan, Overland Park, KS (US); Suresh Kannan, Overland Park, KS (US); Srivatsav Uppu, Overland Park, KS (US)

(21) Appl. No.: 17/669,298

(22) Filed: Feb. 10, 2022

Related U.S. Application Data
(63) Continuation of application No. 63/148,351, filed on Feb. 11, 2021.

(51) Int. Cl. G06Q 30/02

(52) U.S. Cl. CPC G06Q 30/0204

(57) ABSTRACT

The present invention discloses a system for effective media tag management and method thereof. The system (100) comprises a client interface module (101) which is integrated with an external website client. The client interface module (101) provides the website client with provisions to implement media tags on items of interest showcased on the website client. The media tags gather user information and send the information to the client interface module (101) which then transmits the collected user data to a base server (102). The base server (102) is responsible for making the collected user data available to external agencies and users of the system (100). The base server (102) additionally comprises provisions for providing users information about the condition of their data and where it is being sent.

### CROSS-REFERENCE TO RELATED APPLICATIONS

This application claims priority to U.S. provisional application No. 63/148,351 filed on Feb. 11, 2021. The entire content of this application is incorporated by reference herein.

### DESCRIPTION OF THE INVENTION

### Technical Field of the Invention

The present invention relates in general to a system for effective media tag management and a method thereof. The present invention particularly relates to the system for media tag management where the system implements consolidated tag management for efficient tag management and accountability of system data for a user of the system.

### BACKGROUND OF THE INVENTION

Systems for media tag management today comprise systems that involve the usage of individual tags for every item of interest on a website. Items of interest are defined as any object that a website owner wants a visitor of their website to see. For instance, items of interest on e-commerce websites include items and services that the website owner is trying to sell. Items of interest are primarily a website owner's assets that they put on display for viewers to see. To keep a track of how users view and interact with these items of interest, website owners utilize tags on these items of interest. These tags, called media tags collect information about the behaviour of users who visit the website, where the collected information is then used for purposes including targeted advertisements, mailing campaigns, targeted messages and so on. The media tags are implemented on websites through the website client that the user is interacting with. The media tags collect information such as basic user data, the amount of time the user has spent at a particular part of the website, the items of interest that the user has viewed, the number of pages browsed on the website, and so on. The information that the media tags collect is then transmitted to external providers, wherein the external providers are usually agencies that use the collected data for marketing and advertisements. Media tag management is thus an essential aspect of online marketing and advertisements.

When data is collected by websites and is willingly submitted by users visiting the website, the data collected by the website is called first-party data. First-party data usually includes basic user information such as user name and contact details. First-party data is regarded as a safe version of data as the user is made aware of the exact benefactor of the information submitted, which is the website where they submit the data. First-party data is not collected by media tags, but user behaviour and user interaction, is. The behaviour and user interaction data so collected is sent to external agencies through media tag management systems and is termed third-party data, as third-parties such as external agencies are the ultimate benefactors of this data. Websites make the website user aware that third-party data is being collected, usually by means of a short agreement or acknowledgement that is prompted when a user visits a website. Upon agreeing to comply with third-party data collection, the user agrees to have their data sent to unknown third parties, effectively allowing their data to be viewed by anyone. This leads to potential breaches of data and has been the focal point of numerous data privacy campaigns as awareness of data breaches grows amongst users.

Third-party data is collected by website owners by means of third-party cookies, which are essentially media tags that enable website owners to collect user data and provide external agencies with the same. As user awareness about third-party data breaches and cookies has steadily increased, various data protection piracy laws and regulations such as the General Data Protection Regulation (GDPR) and California Consumer Privacy Act (CCPA) have been implemented to regulate the flow of data and information. To comply with these regulations, website owners now have to explicitly seek the consent of website users, seeking permission to allow the website to run third-party cookies to collect data. With growing awareness, users reportedly have been increasingly declining the collection of their data through third-party cookies, resulting in a significant number of websites being unable to run third-party cookies, which in turn leads to no user data being sent to external providers, thus causing a loss in revenue for the website owner. Third-party data is primarily used to target advertisements by external agencies. To avoid encountering advertisements, website users are increasingly using advertisement blockers that further restrict the revenue generated by website owners and external agencies by a loss in advertisement revenue.

Additionally, present-day systems for media tag management comprise systems where the information collected by media tags implemented by a website client on a website is sent to individual external providers. The media tags separately gather information about every item of interest on the website, thus resulting in a numerous number of media tags for any given website that comprises a numerous number of items of interest. When the website is loaded, each individual media tag must be activated, loaded and implemented for use, which causes significant time delays as each individual media tag requires a certain amount of time for activation, loading and implementation. Significant time delays are undesirable as users who experience load time delays on websites are more inclined to avoid visiting the website altogether, resulting in a loss of potential customers and thereby revenue.

The patent application number US20090287572A1 titled “System And Method For Client-Side Advertisement Retrieval” discloses a system for retrieving advertisements includes a client configured to receive content, the content including an identification tag identifying an advertisement type that is associated with the content, the advertisement type corresponding to an advertisement, and a browser associated with the client and configured to render the content, wherein the client uses the information in the identification tag to send a single request for an advertisement creative associated with the advertisement type.

Hence, there exists a need for a system for effective media tag management and method thereof.

### SUMMARY OF THE INVENTION

The present invention overcomes the drawbacks of the prior art by disclosing a system for effective media tag management and a method thereof. The system comprises a client interface module which is integrated with a website client loaded on an external user-interface device, wherein the client interface module comprises provisions to load and implement media tags on the website client subsequent to which the website client loads the media tags onto one or more web sites visited by a plurality of users. Further, the system comprises a base server for receiving, processing, publishing and storing the user data collected using the media tags, wherein the base server comprises an application server, a streaming server, a report server and a data repository.

The application server allows an administrator to manage the operational parameters of the media tags implemented on a website client, enables monitoring of the status of the media tags and detection of any inconsistencies or anomalies during the functioning of media tags. The streaming server collects the user data gathered by media tags on the client website and provides the collected user data in a consolidated form to one or more external agencies. The report server relays status information pertaining to the collected user data transmitted at any given point in time and enables the user to view and manage activities of the system as per requirement. The data repository stores references of all the data that passes through the system.

The method for client-based media tag management comprises the steps of (i) implementing media tags on a website loaded on a website client through the base server, (ii) tracking user behaviour information using media tags and collecting the user behaviour data at the client interface module and (iii) transmitting the collected user data from the client interface module to the external agencies as well as the base server.

The method for server-based media tag management comprises the steps of (i) implementing media tags on a website loaded on a website client through the application server in the base server, (ii) tracking the user behaviour information using media tags, collecting the user behaviour data and transmitting the collected user behaviour data to the base server, (iii) transmitting the collected user data from the client interface module to the base server for data processing and storage, (iv) consolidating the collected user data at the streaming server within the base server and preparing for transmission of the consolidated user data to external agencies and (v) receiving a user data request from the external agencies, recording the request, and accordingly transmitting the requested user data to the appropriate external agency by the streaming server within the base server.

The server-based media tag management method significantly reduces the number of individual interactions of the client interface module with external agencies by processing the collected user data at the streaming server, which reduces the load times of websites, thereby increasing user retention. Further, the system does not collect third-party data or utilize third-party cookies for data collection, thus bypassing all the data breach issues that are directly linked with third-party cookies. This also implies that the system is fully compliant with international data protection laws, ensuring maximum security of sensitive user data. Further, data is collected and shared with external agencies only after user consent is secured.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a pictorial representation of a system for effective media tag management.

FIG. 2 illustrates a flow diagram for a method for client-based media tag management.

FIG. 3 illustrates a flow diagram for a method for server-based media tag management.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention discloses a system for effective media tag management and method thereof. The system comprises a client interface module, which is integrated with an external website client. The client interface module provides the website client with provisions to implement media tags on items of interest showcased on the website client. The media tags gather user information and send the information to the client interface module which then transmits the collected user data to a base server. The base server is responsible for making the collected user data available to external agencies and users of the system. The base server additionally comprises provisions for providing users information about the condition of their data and where it is being sent.

The present invention comprises a system for effective media tag management. The system (100) comprises functionalities to implement media tags on websites through website clients. Website clients are defined as programs installed on external user-interface devices such as personal computers and cellular devices that provide a user with access to the World Wide Web. Common website clients used currently include Mozilla Firefox, Google Chrome, Apple Safari and so on. Common cellular clients include mobile applications development on Apple iOS and Google's Android applications. Media tags are defined as articles of code that track user information such as behaviour and browsing history. Media tags are essentially used to track user information to provide users with targeted advertisements based on their browsing behaviour, as tracked by media tags. Media tags are thus used extensively for online marketing and advertising, where media tags are utilized by external agencies such as advertising agencies. The system (100) thus comprises provisions for providing external agencies with information about user behaviour as gathered by media tags implemented on website clients.

FIG. 1 illustrates a system (100) for effective media tag management. The system (100) comprises a client interface module (101), which is integrated with the website client, loaded on an external user-interface device. The client interface module (101) comprises provisions to load and implement media tags on a website client, after which the website client loads the media tags onto websites that the user visits. Media tags collect information about user behaviour such as which pages on a website the user has viewed, how much time the user spends at which pages, and so on. The media tags are implemented on items of interest on a website and/or cellular application, where items of interest as defined as items that the website owner tracks the traffic on. When a user browses a website or a cellular application, media tags track their behaviour and the collected user data is stored and prepared for transmission. In a preferred embodiment of the present invention, the client interface module (101) is bundled with the website client or a cellular application in the form of a Software Development Kit (SDK) and the SDK installs the software pertaining to media tag tracking.

The system (100) further comprises a base server (102) for receiving, processing, publishing and storing the collected user data. The base server (102) additionally comprises an application server (102a) that allows an administrator to manage the operational parameters of the media tags implemented on a website client. The application server (102a) enables monitoring of the status of the media tags and enables detection of any inconsistencies or anomalies during the functioning of media tags. The application server (102a) additionally allows the administrator to set the effective and expiry dates of media tags as well as decide the website on which the media tags are implemented, where the media tags are placed on the website, which external agencies will be provided with the collected user data to and so on. The application server (102a) thus allows an administrator complete control over the implementation of media tags on websites or cellular applications and to which external agencies the collected user data is transmitted to.

The base server (102) further comprises a streaming server (102b) for collecting the user data gathered by media tags on the client website and providing this information in a consolidated form to external agencies. The streaming server (102b) collects the data generated by the media tags and based on which external agency requires the collected user data, the streaming server (102b) transmits the collected user data accordingly in compliance with user consent. Due to this rerouting, the website client has to only transmit the collected user data to one destination, i.e. the streaming server (102b). The streaming server (102b) receives requests from external agencies as required, thus relieving the website client from the task of directing every tag generated snippet of data to whichever external agency requires it, which is often a time-consuming process.

The base server (102) additionally comprises a report server (102c) for relaying status information about the collected user data transmitted at any given point in time and for enabling the user to view and manage activities of the system (100) as per their needs. The information about the collected data, status information and activity information is available for viewing in the form of a dashboard. This data may be viewed by any personnel who has viewing privileges and includes administrators and users. The report server (102c) comprises provisions to analyse and report the working parameters of the system (100) at any time. The report server (102c) further provides a platform on which the parameters can be viewed by the administrator. The administrator may alter the working of the system (100) as per their requirements based on the report data submitted by the report server (102c). The base server (102) further comprises a data repository (102d) which stores references of all the data that passes through the system (100).

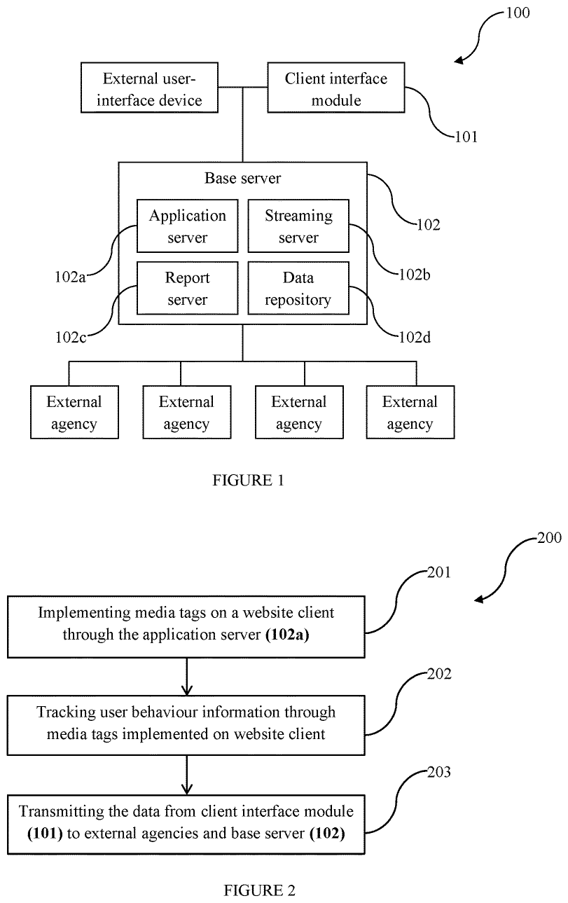

FIG. 2 illustrates a flow diagram for a method for client-based media tag management. The method (200) firstly comprises implementing media tags on a website loaded on a website client or a cellular application through the base server (102) in step (201). The media tags are implemented onto the website client on an external user-interface device through the client interface module (101). The media tags then track user behaviour information and collect it at the client interface module (101) in step (202). The collected user data includes parameters such as which pages on a website the user has viewed, how much time the user spends at which pages, and so on. This collected user data is transmitted from the client interface module (101) to the external agencies as well as the base server (102) in step (203). The condition and status of the collected user data at the base server (102) is available for viewing at the report server (102c), where administrators and users can track the collected user data and ensure that the media tags are behaving as required.

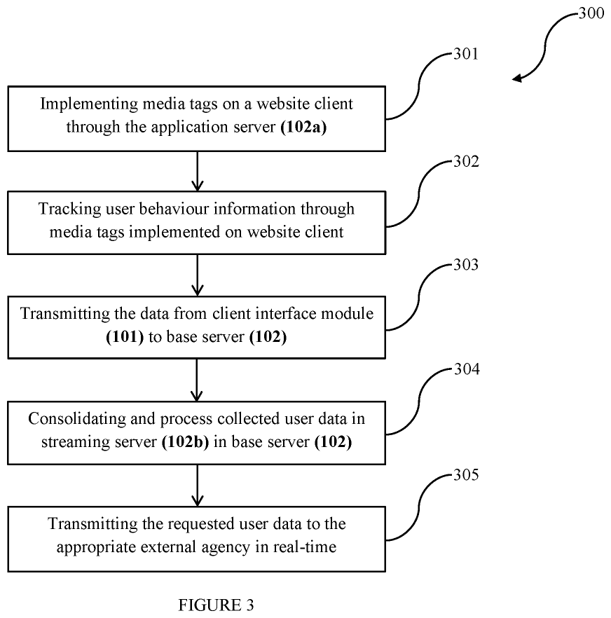

FIG. 3 illustrates a flow diagram for a method for server-based media tag management. The method (300) firstly comprises implementing media tags on a website loaded on a website client through the base server (102) and in particular, through the application server (102a) in step (301). The media tags are implemented onto an external user-interface device through the client interface module (101). The media tags then track user behaviour information and collect it for transmission to the base server (102) in step (302). The collected user data includes parameters such as which pages on a website the user has viewed, how much time the user spends at which pages, and so on. This collected user data is then transmitted from the client interface module (101) to the base server (102) for data processing and storage in step (303). The collected user data is consolidated in step (304) at the streaming server (102b) within the base server (102) and is prepared for transmission to external agencies, wherein the data is collected and shared with external agencies only after user consent is secured. The external agencies signal to the system (100) when user data is required, upon the receival of which the streaming server (102b) records the request and accordingly transmits the requested user data to the appropriate external agency in step (305). This record and user data status is viewable for administrators and users at the report server (102c).

The system (100) thus comprises provisions for both client-based media tag management as shown in FIG. 2 and server-based media tag management as shown in FIG. 3. Client-based media tag management involves transmission of user behaviour information from the web client of a user, through the implementation of media tags. This user information behaviour is directly transmitted to external agencies and the base server (102) simultaneously. This allows users and administrators to view and manage the amount, form and destination of the user behaviour information. Server-side media tag management involves collection and bundling of user behaviour information received by media tags on a web client. This collected user data is sent to the base server (102) where it is further consolidated for transmission to external agencies. The base server (102) keeps a track of all information collected by the media tags and transmits it accordingly to the appropriate external agency. The system (100) is capable of being run in both client-based media tag management and server-based media tag management systems and further allows users to effortlessly switch between the two systems based on their requirements.

The present invention overcomes the drawbacks that are encountered in present-day media tag management systems and methods. The present invention comprises a report server (102c), which provides administrators and users a platform to view the status of the user data as well as the working parameters of the system (100). This enables users to always be aware of how and where their data is being used, thus greatly minimizing the possibilities of data breaches and creating accountability of the system (100). The data is also capable of being sent to users or administrators at any time, allowing users and administrators to verify if the flow of information is occurring as intended. The server-based media tag management method (300) greatly reduces the number of individual interactions of the client interface module (101) with external agencies by processing the collected user data at the streaming server (102b), which reduces the load times of websites, thereby increasing user retention. Further, the system (100) does not collect third-party data or utilize third-party cookies for data collection, thus bypassing all the data breach issues that are directly linked with third-party cookies. This also implies that the system (100) is fully compliant with international data protection laws, ensuring maximum security of sensitive user data.

While at least one exemplary embodiment has been presented in the foregoing detailed description, it should be appreciated that a vast number of variations exist.

Reference numbers:

| Components | Reference Numbers |
|---|---|
| System | 100 |
| Client interface module | 101 |
| Base server | 102 |
| Application server | 102a |
| Streaming server | 102b |
| Report server | 102c |
| Data repository | 102d |

We claim:

1. A system for effective media tag management, the system (100) comprising:
a. a client interface module (101) which is integrated with a website client loaded on an external user-interface device, wherein the client interface module (101) comprises provisions to load and implement media tags on the website client subsequent to which the website client loads the media tags onto one or more websites visited by a plurality of users;
b. a base server (102) for receiving, processing, publishing and storing the user data collected using the media tags, wherein the base server (102) comprises:
i. an application server (102a) for allowing an administrator to manage the operational parameters of the media tags implemented on a website client, wherein the application server (102a) enables monitoring of the status of the media tags and enables detection of any inconsistencies or anomalies during the functioning of media tags;
ii. a streaming server (102b) for collecting the user data gathered by media tags on the client website and providing the collected user data in a consolidated form to one or more external agencies;
iii. a report server (102c) for relaying status information pertaining to the collected user data transmitted at any given point in time and for enabling the user to view and manage activities of the system (100) as per requirement;
iv. a data repository (102d) for storing references of all the data that passes through the system (100).

2. The system (100) as claimed in claim 1, wherein the application server (102a) allows the administrator to set the effective and expiry dates of media tags and decide the website on which the media tags are implemented.

3. The system (100) as claimed in claim 1, wherein the streaming server (102b) collects the data generated by the media tags and transmits the collected user data based on the external agency which has requested for the collected user data.

4. The system (100) as claimed in claim 1, wherein the report server (102c) comprises provisions to analyze and report the working parameters of the system (100) at any given time.

5. A method for effective client-based media tag management, the method (200) comprising the steps of:
a. implementing media tags on a website loaded on a website client through the base server (102);
b. tracking user behaviour information using media tags and collecting the user behaviour data at the client interface module (101);
c. transmitting the collected user data from the client interface module (101) to the external agencies as well as the base server (102);

6. The method (200) as claimed in claim 5, wherein the condition and status of the collected user data at the base server (102) is available for viewing at the report server (102c) thereby allowing administrators and users to track the collected user data and ensure that the media tags are functioning as per requirement.

7. The method (200) as claimed in claim 5, wherein user behaviour data is transmitted directly to external agencies and the base server (102) simultaneously thereby allowing the users and administrators to view and manage the amount, form and destination of the user behaviour information.

8. A method for effective server-based media tag management, the method (300) comprising the steps of:
a. implementing media tags on a website loaded on a website client through the application server (102a) in the base server (102);
b. tracking the user behaviour information using media tags, collecting the user behaviour data and transmitting the collected user behaviour data to the base server (102);
c. transmitting the collected user data from the client interface module (101) to the base server (102) for data processing and storage;
d. consolidating the collected user data at the streaming server (102b) within the base server (102) and preparing for transmission of the consolidated user data to external agencies;
e. receiving a user data request from the external agencies, recording the request, and accordingly transmitting the requested user data to the appropriate external agency by the streaming server (102b) within the base server (102).

9. The method (300) as claimed in claim 8, wherein the base server (102) maintains a record of all the user data collected by the media tags and transmits the collected user data accordingly to the appropriate external agency as per requirement.
